(19) United States
(12) Patent Application Publication
(10) Pub. No.: US 2026/0303553 A1
(43) Pub. Date: Oct. 1, 2026

(54) PROVIDING AN AI BASED GROUP SUMMARY OF UNCONSUMED CONTENT FOR CONNECTED USER DEVICES

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); NAKUL PATEL, NAGPUR (IN)

(21) Appl. No.: 19/094,945

(22) Filed: Mar. 30, 2025

(51) Int. Cl. H04L 51/046; G06F 40/284

(52) U.S. Cl. CPC H04L 51/046; G06F 40/284

(57) ABSTRACT

A method of generating a joint response to communications received by devices belonging to a connected group. The method includes detecting, at an electronic device communicatively connected to one or more group-connected second electronic devices, at least one unanswered communication received from a source device. The method includes triggering each second electronic device to forward a copy of received unanswered communication that can solicit a response. The method includes performing contextual analysis of the unanswered communications and the copies of the received unanswered communications to identify a set of unanswered communications having substantially similar context and received at corresponding second electronic devices from a similar source within a first time window. The method includes constructing, via an artificial intelligence model, for each group of unanswered responses, a group response communicated directly from the electronic device to the source device on behalf of all devices within the group of connected devices.

### BACKGROUND

### 1. Technical Field

The present disclosure generally relates to electronic communication devices, and more specifically to electronic communication devices that can be connected in a group with other communication devices.

### 2. Description of the Related Art

Often, for members of a family or other close knit social group, the plurality of personal electronic communication devices belonging to the respective group members are arranged or configured to operate within a family group consisting of said devices. These devices often belong to the same wireless plan and are enrolled in a group application service, provided via a group server, which is operative to manage the connection between the devices. Members of family groups often receive electronic messages from common sources regarding events or activities that involve the entire group. As group members are unaware of what communications other group members receive, they respond individually to such communications. This can result in multiple members of the family group responding to the originator of the messages with different, even conflicting responses.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1A presents a functional block diagram of example components of an electronic device in a communication environment and having hardware and software components that enable the features of the present disclosure to implement a joint response for a group of related electronic devices, according to one or more embodiments;

FIG. 1B is an additional block diagram representation of the electronic device of FIG. 1A presenting additional components, including components for wireless communications with other devices within a connected device ecosystem, according to one or more embodiments;

FIG. 2 depicts an exemplary group of connected electronic communication devices configured to interact to facilitate production of a joint response to a source device, according to one or more embodiments;

FIG. 3 depicts a dataflow diagram illustrating a communication environment where the electronic device coordinates a joint response to a source device from a group including a plurality of second devices, according to one or more embodiments;

FIGS. 4A-4B, 4C-4D, and 4E-4G depict example sequences of user interfaces during the implementation of joint response for a group of related electronic devices, according to several embodiments;

FIG. 5 depicts a flowchart of a computer-implemented method for implementation of a joint response for a group of electronic devices, according to one or more embodiments.

FIG. 6 depicts a flowchart of an additional computer-implemented method for implementation of a joint response for a group of electronic devices, according to one or more embodiments.

FIG. 7 depicts a flowchart of yet another computer-implemented method for implementation of a joint response for a group of electronic devices, according to one or more embodiments.

### DETAILED DESCRIPTION

According to aspects of the present disclosure, an electronic device, a method, and a computer program product enable joint responses to electronic messages received by some or all of a number of group-connected electronic devices. More specifically, a designated device may receive and analyze recent messages, share, with the group, a summary of the recent messages that originate from a common source within a set time-frame, and then respond to the source of the related recent messages on behalf of the group.

It is common for persons who communicate with different members of a connected group, such as a family, to send messages to multiple members of the group regarding a topic or event that concerns all group members. Often, the group members respond individually to the source of such messages. The responses may differ, even to the point of contradicting each other. Such a barrage of replies sent to the source may result in confusion for the source and possible embarrassment for the group. The present disclosure addresses the above issues by offering a coordinated response from group-connected devices to electronic communications from a common source and/or communications related to a common topic.

According to one embodiment, an electronic device includes a display embedded in a user accessible surface of the electronic device, a communications subsystem that enables the electronic device to communicatively connect via a wireless connection to one or more networks and one or more group-connected second electronic devices, a memory having stored thereon a group-connected devices common response (GDCR) module for consolidating notifications and communications received by multiple group-connected electronic devices and enabling generation and transmission of a group response, and at least one processor communicatively coupled to the display, the communications subsystem, and the memory. The processor executes program code of the GDCR module and is configured to cause the electronic device to detect at least one unanswered communication received at the electronic device from a source device. The processor is configured to cause the electronic device to trigger each device among the one or more group-connected second electronic devices to forward, respectively, a copy of any received unanswered communication that can solicit a response from a respective device. The processor is configured to cause the electronic device to perform contextual analysis of the unanswered communications received at the electronic device and of the copies of the received unanswered communications from the one or more group-connected second devices to identify a set of unanswered communications having substantially similar context and that are received, at corresponding devices within the group of connected devices, from a similar source within a first time window. The processor is configured to cause the electronic device to group, into a shared context message group (SCMG), the set of unanswered communications having substantially similar context. The processor is configured to cause the electronic device to construct, via an artificial intelligence (AI) model, for each SCMG, a group response to be communicated directly from the electronic device on behalf of all corresponding devices within the group of connected devices. The processor is configured to cause the electronic device to transmit the group response to a corresponding source device that originated the unanswered communications.

Additionally, according to one aspect of the disclosure, a method is disclosed for implementing a joint response for a group of related electronic devices via an electronic device communicatively connected via a wireless connection to one or more networks and second electronic devices. The method includes detecting, at the electronic device communicatively connected to one or more group-connected second electronic devices, at least one unanswered communication received from a source device. The method includes triggering each device among the one or more group-connected second electronic devices to forward, respectively, a copy of any received unanswered communication that can solicit a response from a respective device. The method includes performing contextual analysis of the unanswered communications received at the electronic device and of the copies of the received unanswered communications from the one or more group-connected second devices to identify a set of unanswered communications having substantially similar context and received at corresponding devices of the group-connected second electronic devices from a similar source within a first time window. The method includes grouping, into a shared context message group (SCMG), the set of unanswered communications having substantially similar context. The method includes constructing, via an artificial intelligence (AI) model, for each SCMG, a group response to be communicated directly from the electronic device on behalf of all corresponding devices within the group of connected devices. The method includes transmitting the group response to a corresponding source device that originated the unanswered communications.

Also disclosed is a computer program product comprising a non-transitory computer readable medium having computer program product instructions, that when executed by a processor of an electronic device communicatively connected via a wireless connection to one or more networks and second electronic device, configure the electronic device to perform the above-presented and other method functions.

The above description contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with ordinary skill in the art upon examination of the figures and the remaining detailed written description. The above as well as additional objectives, features, and advantages of the present innovation will become apparent in the following detailed description.

Each of the above and below described features and functions of the various aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, the code configuring the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those of ordinary skill in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present innovation is defined by at least the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present innovation. Instances of such phrases in various places within the specification do not necessarily all refer to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest reasonable interpretation given the context in which that term is utilized.

Those of ordinary skill in the art will appreciate that the hardware components and basic configuration depicted in the following figures may vary. The illustrative components are not intended to be exhaustive, but rather are representative to highlight essential components that can be utilized to implement aspects of the described embodiments. For example, other devices/components may be used in addition to, or in place of, the hardware and/or firmware depicted. The depicted examples are not meant to imply architectural or other limitations with respect to the presently described embodiments and/or the general disclosure. Throughout this disclosure, the terms ‘electronic device’, ‘communication device’, and ‘electronic communication device’ may be used interchangeably, and may refer to devices such as smartphones, tablet computers, and/or other computing/communication devices.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural, functional, or otherwise) on the described embodiments.

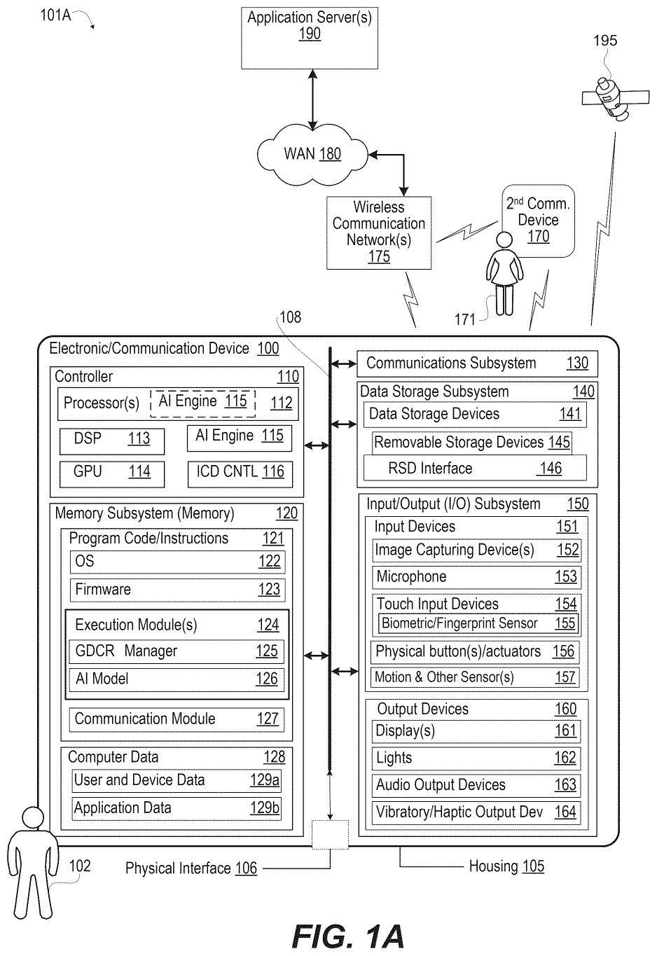

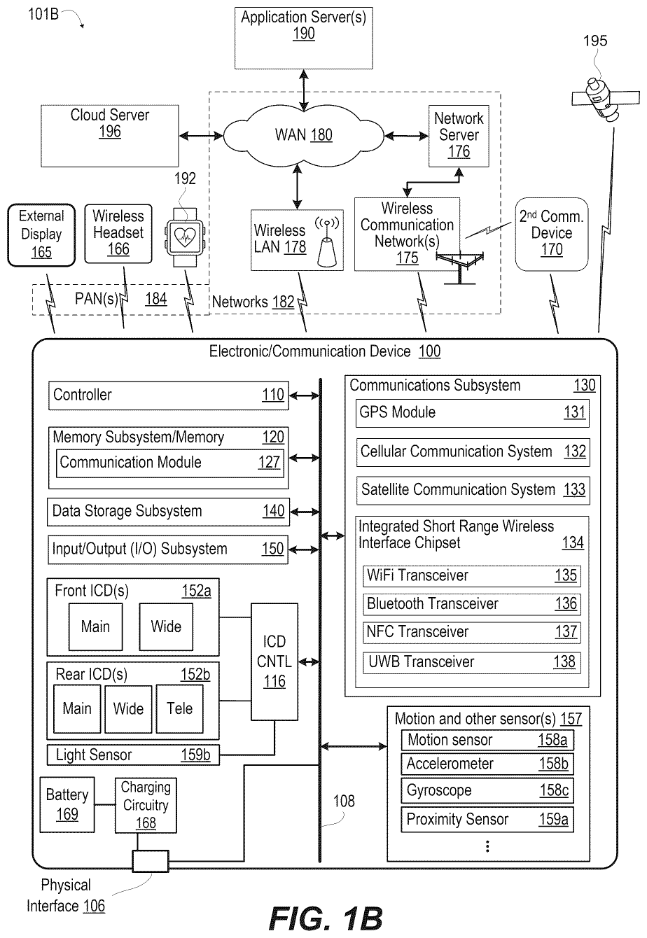

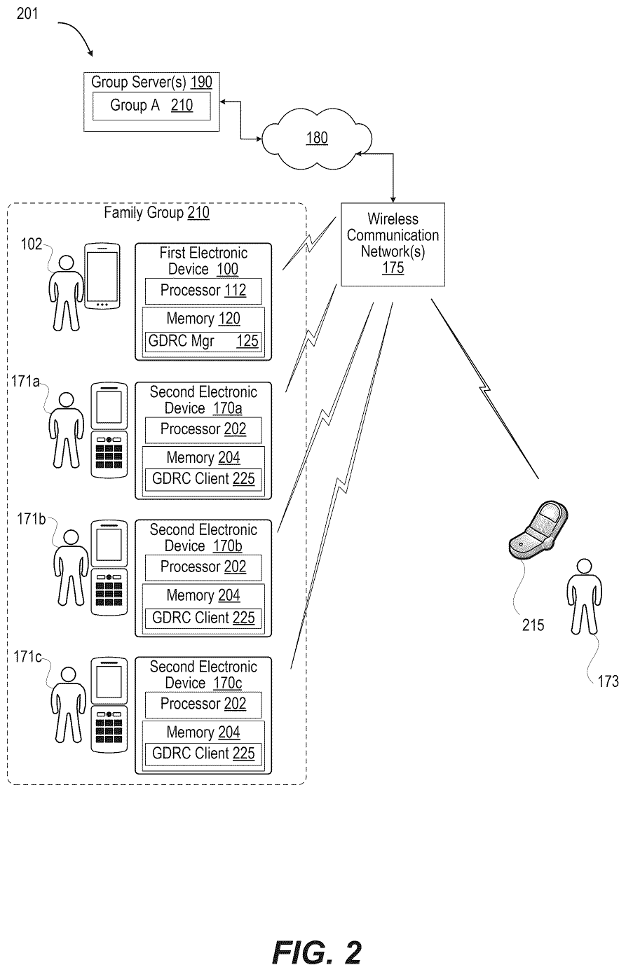

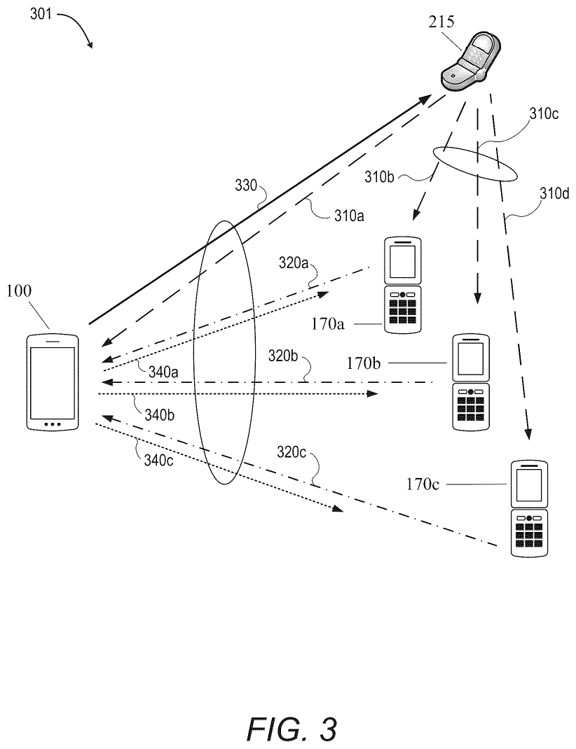

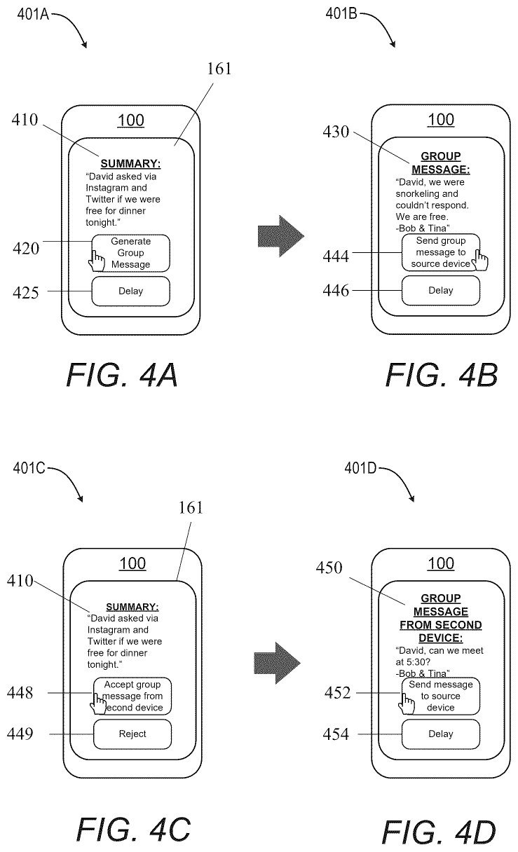

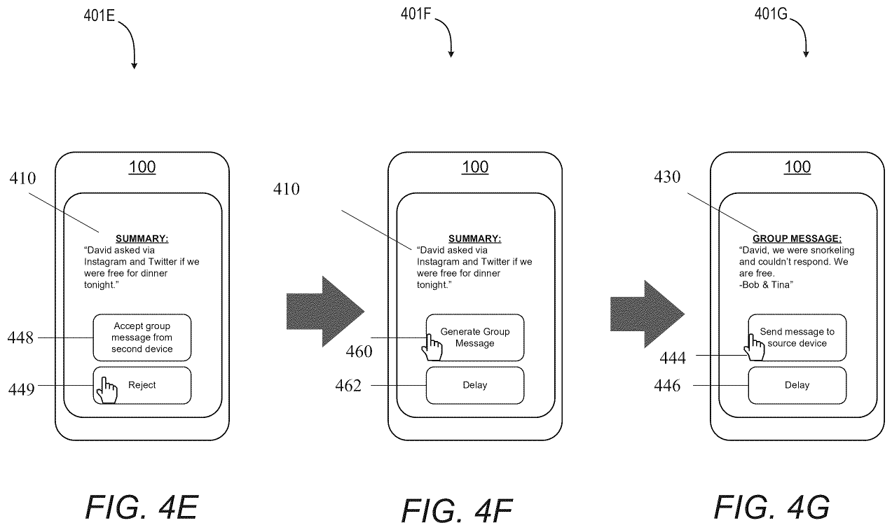

Referring now to the figures and beginning with FIG. 1A, there is illustrated a block diagram of an example electronic device 100 in a communication environment 101 and having hardware and software components, which enable the features of the present disclosure to implement a joint response for a group of related electronic devices, according to one or more embodiments. Examples of electronic device 100 can include, but are not limited to, mobile devices, a notebook computer, a mobile phone, a smart phone, a digital camera with enhanced processing capabilities, a smart watch, a tablet computer, and other types of electronic devices. In the described embodiments, reference is made to a first electronic device 100 and a second electronic device 170. For purposes of the description of the various embodiments herein, FIG. 1 (FIG. 1A and FIG. 1B) is presented as/from the perspective of the first electronic device, which is the device through which a user can receive electronic messages from group-connected second devices and generate a common response. FIG. 2 illustrates a group of connected electronic communication devices including electronic device 100 and several second electronic devices 170 that are interconnected within the group and communicate to facilitate creation of a joint response to a source device. FIG. 3 depicts the flow of data in the communication environment in which a joint message is generated and transmitted in accordance with one or more aspects of the disclosure. FIGS. 4A-4G depict user interfaces presented at the electronic device as the process of FIG. 3 is carried out.

Referring to FIG. 1A, electronic device 100 generally includes controller 110, memory (or memory subsystem) 120, communications subsystem 130, data storage subsystem 140, and input/output subsystem 150, all contained within or extended from an exterior surface of device housing 105. Controller 110 is shown communicatively connected/coupled via system interlink 108 with each of the subsystems 120, 130, 140, and 150, and is directly or indirectly connected with the individual components within each subsystem 120, 130, 140, and 150. System interlink 108 represents internal components that facilitate internal communication by way of one or more shared or dedicated internal communication links, such as internal serial or parallel buses. As utilized herein, the term “communicatively coupled” means that information signals are transmissible through various interconnections, including wired and/or wireless links, between the components. The interconnections between the components can be direct interconnections that include conductive transmission media or may be indirect interconnections that include one or more intermediate electrical components.

Controller 110 includes processor 112, which includes one or more central processing units (CPUs) or data processors. Processor 112 performs many of the features of controller 110 and references to features performed by controller 110 can be interchangeably referred to herein as features of processor 112, and vice-versa. In some embodiments, the various functions associated with controller 110 are integrated into processor 112, and accordingly, references made herein to controller and/or processor are understood to refer to one or both components as providing a single management component within the electronic device 100. For simplicity in describing the features of the electronic device 100, the operational functions provided by one or more operational components within controller 110, including those provided by processor 112 are collectively described as being performed by controller 110. Collectively, components integrated within controller 110 support computing, classifying, processing, transmitting and receiving of data and information, and presenting of graphical and photographic images within a display.

As illustrated, controller 110 can also include one or more digital signal processors 113 graphics processing units (GPUs) 114, artificial intelligence (AI) engine 115, and image capturing device (ICD) controller 116. In some embodiments, the functionality of each of these additional processing components can be integrated with processor(s) 112. For example, processor 112 can, in some embodiments, include dedicated AI engine 115 and image signal processors (ISPs) (not shown). Processor 112 can further include other processors such as auxiliary processor(s) that may act as a low power consumption, always-on sensor hub for physical sensors.

Controller 110 manages, and in some instances directly controls, the various functions and/or operations of communication device 100. These functions and/or operations include, but are not limited to including, application data processing, communication, location and navigation tasks, image processing, and signal processing. In one or more alternate embodiments, electronic device 100 may use hardware component equivalents for application data processing and signal processing. For example, electronic device 100 may use special purpose hardware, dedicated processors, general purpose computers, microprocessor-based computers, micro-controllers, optical computers, analog computers, dedicated processors and/or dedicated hard-wired logic. Controller 110 can, in some embodiments, also include a hardware acceleration (HA) unit, which can establish direct memory access (DMA) sessions to route network traffic to various elements within electronic device 100 without direct involvement from processor 112 and/or a device operating system 122.

Memory subsystem (or memory) 120 may include a combination of volatile and non-volatile memory, such as random-access memory (RAM) and read-only memory (ROM). Memory subsystem 120 stores program code/instructions 121 for execution by processor 112 to configure processor 112 (and more generally electronic device 100) to provide the operational functions and features described herein. Program code/instructions 121 (or program code 121 for short) includes instructions for an operating system (OS) 122, and firmware 123, such as basic input/output system (BIOS) or Uniform Extensible Firmware Interface (UEFI). Program code 121 includes execution module(s) 124 that collectively provide(s) the various features of the disclosure. Execution module(s) 124 include, without limitation, group-connected devices common response (GDCR) manager 125, which provides the features and operating functionality of the disclosed embodiments when the corresponding program instructions of GDCR manager 125 are processed by/within processor 112/controller 110. Specifically, GDCR module provides program instructions for receiving and analyzing, at the electronic device 100, unread messages from the group-connected second electronic devices 170, generating a group response for groups of messages having a common source or topic, and transmitting a common response to the source device that originated the messages.

Execution module(s) 124 further include AI module(s) 126. In one or more embodiments, processor 112 can utilize AI modules 126 to provide AI functionality of processor-integrated AI engines 115. In other embodiments, AI modules 126 are directly utilized by AI engine 115. In one or more embodiments, AI module 126 is integrated as a sub-module within GDCR manager 125 and is trained to support the AI features of GDCR manager 125. AI module(s) 126 may include an artificial neural network, a decision tree, a support vector machine, Hidden Markov model, linear regression, logistic regression, Bayesian networks, and so forth. AI module(s) 126 can be individually trained to perform specific tasks and can be arranged in different sets of AI modules to generate different types of output. Training of AI module(s) 126 is the process by which AI modules are trained to perform specific tasks or achieve certain objectives. The training involves providing the model with a large amount of data and allowing the model to learn from patterns and relationships within that data.

Each of the above-introduced module(s) and/or application(s) provides program instructions/code that are processed by processor 112 and which configures processor 112 (and/or controller 110) and/or other operational components of electronic device 100 to cause the electronic device 100 to perform specific operations and functions, as described herein. Descriptive names assigned to these modules add no functionality and are provided solely to assist in identifying the underlying features performed by processing the different modules. For example, GDCR manager 125 can include program instructions that cause or configure controller 110 to cause electronic device 100 to detect at least one unanswered communication received at the electronic device 100 from a source device. The controller 110 is further configured to cause the electronic device 100 to trigger each device among the one or more group-connected second electronic devices 170 to forward, respectively, a copy of any received unanswered communication that can solicit a response from a respective device. The controller 110 is further configured to cause the electronic device 100 to perform contextual analysis of the unanswered communications received at the electronic device 100 and of the copies of the received unanswered communications from the one or more group-connected second devices 170 to identify a set of unanswered communications having substantially similar context and that are received, at corresponding devices within the group of connected devices, from a similar source within a first time window. The controller 110 is further configured to cause the electronic device 100 to group, into a shared context message group (SCMG), the set of unanswered communications having substantially similar context (e.g., originating from a similar source and/or related to a similar topic). The controller 110 is further configured to cause the electronic device 100 to construct, via an artificial intelligence (AI) model 126, for each SCMG, a group response to be communicated directly from the electronic device 100 on behalf of all corresponding devices within the group of connected devices. The controller 110 is further configured to cause the electronic device 100 to transmit the group response to a corresponding source device from which the SCMG communications originated.

In a further embodiment, the controller 110 is further configured to cause the electronic device 100 to transmit, to each second electronic device 170 among the corresponding devices, an indication that the received unanswered communication has been responded to via the group response. In a related embodiment, the controller 110 is further configured to cause the electronic device 100 to, in transmitting the indication, provide with the indication a summary of the group response and trigger a receiving second electronic device 170 to annotate the received, unanswered communication with the summary of the group response. In one or more embodiments, the indication also triggers the second electronic device 170 to remove or modify the message so that the message is no longer indicated as unanswered.

In another embodiment, the controller 110 is further configured to cause the electronic device 100 to detect when one or more connected second electronic devices 170 are within a preset distance threshold of the electronic device 100, and to initiate a query for new communications, which may be recently-received unanswered (RRU) communications, in some embodiments, in response to determining that one or more connected second electronic devices 170 are within the preset distance threshold.

In another embodiment, the controller 110, in order to identify a set of unanswered communications having substantially similar context, the controller 110 is further configured to cause the electronic device 100 to identify an origination source of the RRU communications from one or more devices belonging to a same contact identify, using natural language processing (NLP), that the RRU communication is directed towards a same topic, and identify based on a time stamp metadata that the RRU communication was received within a time window pre-established to suggest an association of similar topics and context.

In another embodiment, the controller 110 is further configured to cause the electronic device 100 to complete a local retrieval of the copy of the RRU communication from a plurality of different communication applications executing on the electronic device 100, and trigger a second processor 202 of a second electronic device 170 within the group to analyze received communications within each of a plurality of local communication applications to identify and return a copy of and/or metadata/information related to the RRU communications.

In another embodiment, the controller 110, in response to completing the transmission of the group response, is further configured to cause the electronic device 100 to transmit a clear signal to each corresponding device to trigger clearance of a pending notification of a corresponding RRU message from among the RRU communications having a same context.

In another embodiment, the controller 110 is further configured to cause the electronic device 100 to initiate the triggering of each device among the one or more group-connected second electronic devices 170 in response to detection of a predetermined trigger word uttered by the user of the electronic device 100.

In another embodiment, the controller 110 is further configured to cause the electronic device 100 to send a prompt to the group-connected second electronic devices 170 giving each user of the respective second electronic devices an option to enter a selective sharing configuration whereby the group-connected second electronic devices 170 may restrict the RRU communications forwarded to the electronic device to RRU communications from specified communication applications.

In another embodiment, the controller 110 is further configured to cause the electronic device 100 to receive a request from a group-connected second electronic device 170 to initiate the group response on behalf of all connected devices. The controller 110 is further configured to cause the electronic device 100 to, in response to receiving the request, generate and present a prompt for entry of a user input that indicates one of: approve the request and transmit a group response to the corresponding source device; or deny the request and transmit the denial of the request to the second electronic device 170.

Other features provided by GDCR manager 125 and/or generally by controller 110 and/or electronic device 100 are described in further detail throughout this disclosure.

Program code 121 can further include instructions/code for other applications (not shown) providing different features of/within electronic device 100. In one or more embodiments, program code 121 may be integrated into a distinct chipset or hardware module as firmware that operates separately from other executable program code. Portions of program code 121 may be incorporated into different hardware components that operate in a distributed or collaborative manner.

Memory subsystem 120 also includes computer data 128. During execution of program code 121, processor 112 may access, use, generate, modify, store, or communicate computer data 128, such as user and device data 129a and application data 129b. Computer data 128 may incorporate “data” that originated as raw, real-world “analog” information that consists of basic facts and figures. Computer data 128 includes different forms of data, such as numerical data, images, coding, notes, and financial data, as well as data presenting video, graphics, text, and images. Computer data 128 may originate at communication device 100 or may be retrieved from a remote device via communications subsystem 130. Electronic device 100 may store, modify, present, or transmit computer data 128.

Communications subsystem 130 includes various components that enable electronic device 100 to communicate with external communication networks and other devices, such as second electronic device 170 and application server(s) 190, etc., via communications subsystem 130. According to one or more embodiments, communication module 127 presented within program code 121 includes instructions supporting the use of communications subsystem 130 to establish communication interfaces enabling communication by electronic device 100 with these external networks and devices.

Data storage subsystem 140 of electronic device 100 includes data storage device(s) 141. Controller 110 is communicatively connected, via system interlink 108, to data storage device(s) 141. Data storage subsystem 140 provides stored versions of program code 121 and computer data 128 on nonvolatile storage that is accessible by controller 110. The program code 121 can be loaded into memory 120 for execution/processing by controller 110. In one or more embodiments, data storage device(s) 141 can include hard disk drives (HDDs), optical disk drives, and/or solid-state drives (SSDs), etc.

Data storage subsystem 140 of communication device 100 can include removable storage device(s) (RSD(s)) 145, which are received in RSD interface 146. Controller 110 is communicatively connected to RSD 145, via system interlink 108 through RSD interface 146. In one or more embodiments, RSD 145 is a non-transitory computer program product or computer readable storage device that stores program code and associated data, including a copy of GDCR manager 125 and AI module(s) 126, which may be executed by a processor associated with a user device, such as electronic device 100. Controller 110 can access data storage device(s) 141 or RSD(s) 145 to provision electronic device 100 with stored program code 121 and computer data 128 that, when executed/processed by processor 112, the program code configures processor 112 and/or more generally electronic device 100, to provide the various functions described herein.

I/O subsystem 150 includes input devices 151 such as, but not limited to, image capturing device(s) (ICDs) 152, microphone 153, and touch input devices 154 (e.g., touch screens, keys, or buttons) for use by user 102 to interface with electronic device 100. Touch input devices 154 can include a biometric/fingerprint sensor 155 for biometric input. Biometric/fingerprint sensor 155 can be used to read/receive biometric data, such as fingerprints, to identify or authenticate a user. In some embodiments, the biometric sensor 155 can supplement an ICD (camera), which captures images for user detection/identification via facial recognition.

Input devices 151 may include physical buttons/actuators 156 that can be located on a periphery of the device housing 105. Physical buttons 156 may provide controls for volume, power, and ICDs 152. Microphone 153 can also be referred to as an audio input device. In some embodiments, microphone 153 may be used for identifying a user via voiceprint, voice recognition, and/or other suitable techniques. Input devices 151 can also include one or more motion or other sensor(s) 157, which are further defined in the FIG. 1B description.

With reference to FIG. 1B, as illustrated, motion and other sensor(s) 157 of electronic device 100 include, but are not limited to, one or more motion sensor(s) 158a, one or more accelerometers 158b, one or more gyroscopes 158c, and proximity sensor 159a, etc. Motion sensor(s) 158a detect movement of electronic device 100 and provide motion data to processor 112 indicating the spatial orientation, position and movement of electronic device 100. Accelerometers 158b measure linear acceleration of movement of electronic device 100 in multiple axes (X, Y and Z). For example, accelerometers 158b can include three accelerometers, where one accelerometer measures linear acceleration in the X axis, one accelerometer measures linear acceleration in the Y axis, and one accelerometer measures linear acceleration in the Z axis. Accelerometers 158b can be used to calculate the orientation/position of electronic device 100 relative to the earth and can also be referred to as a gravity sensor. Gyroscope 158c measures rotation or angular rotational velocity of electronic device 100. Proximity sensor 159a senses the presence of nearby objects. In one embodiment, proximity sensor 159a can be an infrared (IR) sensor that detects the presence of a nearby object, such as when electronic device 100 is in a pocket of a user. Electronic device 100 can also include one or more light sensors 159b, which detect the luminance and/or intensity (i.e., the amount) of ambient light surrounding the electronic device 100.

Referring again to FIG. 1A, I/O subsystem 150 includes output devices 160 such as, but not limited to, display(s) 161, lights 162, audio output devices 163, and vibratory and/or haptic output devices 164. In one or more embodiments, electronic device 100 includes an integrated display 161 which incorporates a tactile, touch screen interface that can receive user's tactile/touch input. As a touch screen device, integrated display 161 allows a user to provide input to and/or to control electronic device 100 by touching features within a user interface presented on integrated display 161. Tactile, touch screen interface (154) can be utilized as an input device. The touch screen interface 154 can include one or more virtual buttons or selectable affordances. In one or more embodiments, when a user applies a finger or stylus on the touch screen interface (154) in the region demarked by the virtual button, the touch of the region causes the processor 112 to execute code to implement a function associated with the virtual button. In some implementations, integrated display 161 is integrated into a front surface of electronic device housing 105 along with front image capturing devices (not specifically shown), while the higher quality ICDs are located on a rear surface of housing 105. Other embodiments provide for multiple integrated displays within electronic device 100 and references to display(s) 161 are assumed to refer to one or all of these multiple integrated displays. Yet other embodiments can include external displays (161) that are not integrated into the main body of electronic device 100 but are wired or wirelessly connected to the other components of electronic device 100 to provide the input/output features similar to integrated display 161.

Vibration device 164 can cause electronic device 100 to vibrate or shake when activated. Vibration device 164 can be activated during an incoming call or message in order to provide an alert or notification to a user of electronic device 100. In one or more embodiments, integrated display 161, audio output devices (or speakers) 163, and vibration/haptic device 164 can generally and collectively be referred to as output devices.

With reference again to FIG. 1B and with continuing reference to FIG. 1A, there is presented another view of electronic device 100 with components enabling electronic device 100 to function as a mobile communication device, within an expanded communication environment 101B. In addition to the functional and operational components already presented by and described within the description of FIG. 1A, FIG. 1B further illustrates expanded communications subsystem 130 with additional communication components and interfaces enabling electronic device 100 to perform wireless communications within an expanded communication environment 101B that includes other devices.

Communications subsystem 130 includes a global positioning system (GPS) module 131 that enables electronic devices to communicate with and receive GPS location data from GPS satellite(s) 195. In one or more embodiments, GPS module 131 receives geospatial input from GPS broadcasts of time data and location data from GPS satellite(s) 195 to obtain geospatial location information about the physical location of electronic device 100.

In one or more embodiments, controller 110, via communications subsystem 130, performs multiple types of cellular over-the-air (OTA) or non-cellular wireless communication, such as by using a Bluetooth connection or other personal access network (PAN) connection. As shown, communications subsystem 130 includes cellular communication system 132, which includes at least one radio frequency RF front end coupled to one or more antennas. In one or more embodiments, cellular communication system 132 can include a communication module with one or more baseband processors or digital signal processors, one or more modems, and a radio frequency (RF) front end having one or more transmitters and one or more receivers. In one or more embodiments, controller 110, via communications subsystem 130, may communicate via an OTA cellular connection with radio access networks (RANs) over a cellular wireless communication network (CWCN) 175. CWCN 175 can be a terrestrial network and include a plurality of base stations and associated network server(s) 176, in one embodiment. Cellular communication system 132 allows electronic device 100 to communicate wirelessly with CWCN 175 via transmissions of communication signals (represented as lightning bolts) to and from network communication devices, such as base stations or cellular nodes, of CWCN 175. Alternatively, or in addition, CWCN 175 can include a satellite network, and electronic device 100 connects to CWCN 175 using satellite communication system 133. Cellular communication system 132 and satellite communication system 133 enable electronic device 100 to utilize long distance wireless communication capabilities.

In one or more embodiments, communications subsystem 130 includes integrated short range wireless interface chipset 134 having one or more of Wi-Fi transceiver (TxRX) 135, Bluetooth (BT) TxRx 136, near field communication (NFC) transceiver 137, and ultra-wideband (UWB) transceiver 138. In one or more embodiments, the short-range communication devices are not integrated on a single chipset but can be separately provided hardware components. In one or more embodiments, electronic device 100 can communicate wirelessly with external wireless devices, such as a WiFi router of a wireless local area network (WLAN) 178 and/or second electronic device 170, via one or more short-range wireless interface(s). Second electronic device 170 can be a communication device, such as a smartphone, and/or can be similarly configured as electronic device 100. In one or more embodiments, electronic device 100 can receive Internet or Wi-Fi based calls, text messages, multimedia messages, and other notifications via a combination of wireless and wired networks (generally networks 182).

In one or more embodiments, networks 182 can include CWCN 175, WLAN 178, and Wide Area Network (WAN) 180, such as the Internet. In one or more embodiments, WAN 180 can enable electronic device 100 to access application servers 190, which can provide a downloadable version of GDCR manager 125 and/or access to other applications, online transactions, and resources. In one or more embodiments, the WAN 180 can enable electronic device 100 to access a cloud server 196, which can receive and store data from electronic device 100 to be downloaded and used by second electronic device 170. In one or more embodiments, networks 182 can also include personal area networks (PAN) 184, which are individually created with second devices via one of short-range wireless devices from among Wi-Fi TxRX 135, BT TxRx 136, NFC transceiver 137, and UWB transceiver 138. Example second devices include external display 165, wireless headset 166, and wearable computing device 192. External display 165 can be a stand-alone monitor/display or a display integrated into a second electronic device, such as a laptop computer. In at least one embodiment, connection to the external display 165 can be wired and can include an intermediate connection device, such as a docking station device. In one or more embodiments, wearable computing device 192, such as a smartwatch, fitness tracker, or the like, may be paired with electronic device 100, and provide biometric data such as heart rate, breathing rate, and the like, to the electronic device 100 via the paired communication link.

Electronic device 100 also includes a physical interface 106. Physical interface 106 of electronic device 100 can serve as a data port and can be used as a power supply port that is coupled to charging circuitry 168 which feeds electrical power to device battery 169 to enable recharging of device battery 143 and/or powering of electronic device 100. As a data port, physical interface 106 can enable electronic device 100 to be physically coupled via a cable or docking station port to a second device, such as external display 165.

FIG. 1B also presents additional details of ICD(s) 152 of electronic device 100. Throughout the disclosure, the term image capturing device (ICD) is synonymous with and/or utilized interchangeably with any one of the cameras of electronic device 100. ICD(s) (or cameras) 152 includes front cameras 152a and rear cameras 152b. In one embodiment, each of front cameras 152a and rear cameras 152b are communicatively coupled to ICD controller 116. ICD controller 116 supports the processing of image data from front cameras 152a and rear cameras 152b. Front cameras 152a can include a main camera and a wide-angle camera. Rear ICD(s) can include a main camera, a wide-angle camera, and a telephoto camera. Both sets of cameras 152 include image sensors that can capture images that are within the field of view (FOV) of each respective camera 152. In one or more embodiments, one or more of the cameras can be utilized to enable biometric authentication using facial image or iris scan recognition.

In the description of each of the following figures, reference is also made to specific components illustrated within the preceding figure(s). Similar or same components are presented with the same leading reference number.

FIG. 2 depicts an exemplary group of connected electronic communication devices configured to interact to facilitate production of a joint response to a source device, according to one or more embodiments. An example group environment to facilitate production of a joint response includes a plurality of electronic communication devices arranged or configured to operate within Family Group 210 consisting of at least the electronic communication device 100 of first user 102 and one or more second electronic communication device(s) 170 of respective second user(s) 171. Here, 3 second electronic communication devices (i.e., 170a, 170b, and 170c) and their respective second users (i.e. 171a, 171b, and 171c) are shown, though more or fewer second electronic communication devices 170 and corresponding users 171 may be interconnected within the example family group 210. In one example, the user 102 and second users (i.e. 171a, 171b, and 171c) belong to the same wireless plan or are enrolled in a group application service, provided via group server 190, which is operative to manage the connection between the electronic communication device 100 and second electronic communication devices (e.g., 170a, 170b, and 170c). The group server 190 connects to a WAN 180, such as the internet. The WAN 180 connects to wireless communication network 175 which connects the electronic communication device 100 and second communication devices (e.g., 170a, 170b, and 170c) to each other and to a source device 215 operated by a third person 173.

Electronic communication device 100 is operative, via processor 112, to execute GDRC manager 125, stored in memory 120. In executing GDRC manager 125, processor 112 causes electronic device 100 to facilitate production, in concert with second electronic device(s) 170, of a group response to messages received from source device 215 as described below. Each second electronic communication device 170 includes memory 204 that may store a local copy of group-connected devices common response (GDCR) client 225 for implementing the second device features of the disclosure, by configuring processor 202 to control hardware and software components of second electronic device 170 that are roughly analogous to hardware components of electronic communication device 100. In one or more embodiments, GDCR client 225 includes program instructions that configure processor 202 to cause the group-connected second electronic device(s) 170, upon prompting by the electronic device 100, to forward, to the electronic device 100, a copy of any received RRU communication that can solicit a response from a respective device. After the first electronic device 100 has transmitted the group response to a corresponding source device 215 that originated the RRU communications, each second electronic device 170 is operative to receive from the electronic device 100 an indication that the received RRU communications have been responded to via the group response. Any second electronic device 170 may also, upon prompting by the electronic device 100, analyze received communications within each of a plurality of local communication applications to identify and return the RRU communications. A single group member is designated to generate and send a joint response to the originating device 215 from a designated managing device. In this illustrative embodiment, electronic device 100 is assumed to be and is described as performing the role of a managing device of the family group 210 to perform the various features and functions described herein. However, it is appreciated that any one of the devices within family group 210, including any one of the second devices 170, can be designated (or can designate itself) to perform the role of the managing device. Thus, one of the second electronic device(s) 170 may also send a request to the electronic device 100 (and the other second electronic device(s) 170 seeking permission to initiate the group response on behalf of all connected devices in place of the electronic device 100.

FIG. 3 depicts a dataflow diagram illustrating a communication environment where the electronic device 100 coordinates a joint response to a source device 215 from a group of connected devices, including electronic device 100 and a plurality of second devices 170, according to one or more embodiments. One or more source devices 215 may send electronic messages to the electronic device 100 or any of the group-connected second devices (e.g., 170a, 170b, and 170c). These messages 310a-310d may be transmitted and received from a variety of different mediums including phone, text, email, or messaging applications. Following the receipt of messages 310a from the source device(s) 215, and based on a trigger or trigger condition, the electronic device 100 may initiate the creation of a joint response by detecting at least one RRU communication (e.g., messages 310a) received at the electronic device 100 from a source device 215 and triggering each device among the one or more group-connected second electronic devices (e.g., 170a, 170b, and 170c) to forward, respectively, a copy of any received RRU communication (e.g., messages 310b-310d) that can solicit a response from the respective second electronic device 170. Alternatively and/or in addition, the electronic device 100 may initiate the creation of a joint response by detecting when one or more connected second electronic devices (e.g., 170a, 170b, and 170c) are within a preset distance threshold of the electronic device 100 and initiating a query (e.g., via transmission of a request, such as by group message signals (not shown) originating from electronic device 100) of the connected second electronic devices 170 for RRU communications, in response to determining that one or more connected second electronic devices 170 are within the preset distance threshold. The electronic device 100 receives copies or summary details 320a-320c about the RRU communications and then performs contextual analysis of the RRU communications to identify a set of RRU communications having substantially similar context and that are received, at corresponding devices within the group of connected devices, from a similar source (e.g., 215) within a first time window (e.g., within 30 minutes of each other). Following the performance of contextual analysis, the electronic device 100 transmits a group response 330 to a corresponding source device 215 from which the RRU communications originated. The electronic device 100 sends a clear signal 340a-340c to each group-connected second electronic device (e.g., 170a, 170b, and 170c) to trigger clearance of a pending notification about the RRU communications having a same context.

FIG. 3 presented the dataflow that occurs when the group-connected devices common response (GDCR) module is executed to effect implementation of a joint response for a group of related electronic devices.

FIGS. 4A-4B, 4C-4D, and 4E-4G depict example user interfaces presented on display 161 of electronic device 100 (FIG. 1) during the implementation of a joint response for a group of related electronic devices, according to several embodiments. FIGS. 4A-4B depict a sequence of user interfaces presented to the user 102 for summarizing RRU communications from a source device 215 and generating a group response at electronic device 100. FIGS. 4C-4D and FIGS. 4E-4G depict two alternative sequences of user interfaces presented on display 161, where processor 112 evaluates and summarizes RRU communications from a source device 215 and evaluates a group response generated at a second electronic communication device 170.

In FIG. 4A, first UI 401A includes a rendering of a summary of RRU messages 410, generated by the electronic communication device 100. The electronic communication device 100 forwards the summary of RRU messages 410 to the second electronic communication devices 170. First UI 401A also presents selectable options including generate group message option 420 and delay option 425. Accordingly, the user 102 (FIG. 1) is provided the opportunity to compose a message to be sent to the source device 215 on behalf of the entire group 104. Alternatively, the user 102 can postpone generating the group message. In one or more embodiments, the controller 110, in order to identify a set of RRU communications having substantially similar context, causes the electronic device 100 to identify an origination source 215 of the RRU communication from among a plurality of devices belonging to a same contact, and identifying, using natural language processing (NLP), that the RRU communication is directed towards a same topic. The electronic device 100 also identifies, based on a time stamp metadata, that the RRU communication was received within a time window pre-established to suggest an association of similar topics and context. In addition to the source and topic of a message and or message timestamp metadata, contextual analysis of the RRU messages can take into account the applications from which the message originated, and themes, events, or persons referenced in the message. Following receipt/acquisition of these data and additional information regarding the physical environments and/or locations of the electronic communication devices (e.g. 100. 170a, 170b, and 170c) of family group 114 and/or information entered by users (e.g. 102, and 721), a summary and a group message are generated by electronic device 100, utilizing one or more AI models 126. The user 102 may delay generating the group message, for example, in order to revise the summary of RRU messages 410. As shown by the hand selection icon, the user 102 has opted to select generate group message option 420. As a result of that selection, the first UI 401A transitions to (i.e., is replaced on display 161 by) second UI 401B of FIG. 4B.

FIG. 4B includes second UI 401B in which the user is presented the group message 430 along with send group message to source device option 444 and a delay option 446. Accordingly, the user 102 is provided the opportunity to forward the group message 430 to the source device 215. Once group message 430 is forwarded, electronic device 100 transmits a copy of the group message 430 to be locally stored as a joint response to the received communication at each of second electronic communication devices 170. Alternatively, the user may postpone forwarding the group message 430. The user 102 might delay forwarding the group message, for example, in order to have the electronic device 100 utilize one or more AI models 126 to create a different group message or to personally edit or recreate the group message 430. As shown, the user 102 has opted to select send group message to source device option 444.

In FIG. 4C, third UI 401C includes a rendering of a summary of RRU messages 410, generated by the electronic communication device 100. The electronic communication device 100 forwards the summary of RRU messages 410 to the second electronic communication devices 170. Third UI 401C also presents selectable options including accept group message from second device option 448 and delay option 449. Accordingly, the user 102 is provided the opportunity to accept a group message composed by a second electronic communication device 170 that can be forwarded to the source device 215 on behalf of the entire group 104 in response to the RRU messages. Alternatively, the user 102 can choose to reject and discard the group message from the second device 170. The user 102 might reject/discard the group message from the second device 170, for example, in order to have the electronic device 100 utilize one or more AI models 126 to create a different group message or to edit or personally re-create a group message. As shown, the user 102 has opted to select accept group message from second device option 448. As a result of that selection, the third UI 403C transitions to (i.e., is replaced on display 161 by) fourth UI 401D of FIG. 4D.

FIG. 4D includes fourth UI 401D in which the user is presented a group message from the second device 450 along with a send message to source device option 452 and a delay option 454. Accordingly, the user 102 is provided the opportunity to forward the group message from the second device 450 to the source device 215. Once the group message from the second device 450 is forwarded, electronic device 100 transmits a copy of the group message 430 to be locally stored as a joint response to the received communication at each of second electronic communication devices 170. Alternatively, the user may postpone forwarding the group message from the second device 450. The user 102 might delay forwarding the group message from the second device 450, for example, in order to prompt the second electronic communication device 170 to transmit a different message to electronic device 100. As shown, the user 102 has opted to select send message to source device option 452.

FIG. 4E includes fifth UI 401E which is similar to third UI 401C except for the user selection of the reject option 449. As a result of that selection, the fifth UI 401E transitions to (i.e., is replaced on display 161 by) sixth UI 401F of FIG. 4F.

FIG. 4F includes sixth UI 401F, which presents the user with the opportunity to generate a group message 460 via electronic device 100 utilizing one or more AI models 126 or delay creating a group message 462. As shown, the user 102 has opted to generate a group message 460. As a result of that selection, the sixth UI 401F transitions to (i.e., is replaced on display 161 by) seventh UI 401G of FIG. 4G. FIG. 4G includes seventh UI 401G which is identical to second UI 401B. As in second UI 401B, the user 102 has opted to select send group message to source device option 444.

Regarding FIGS. 4A-4G, RRU messages having similar context may originate from a single source device 170 or single third person 173. In an alternate embodiment, RRU messages may originate from multiple source devices 215 that are associated with multiple third persons 173. For example, members of family group 210 may receive messages from a single third person 173 (e.g. a neighbor) inquiring about what dish members of family group 210 are bringing to an upcoming potluck hosted by single third person 173. Alternatively, multiple members of a second family group could send messages to members of family group 210 giving updates regarding various reading assignments for various classes, based on age group, at an upcoming vacation bible school event which members of both family groups will attend. In these instances a single group response may be appropriate if two members of the source family forward the same flyer or information about the assignments to multiple members of the recipient family group. A single response is generated by/received at the selected responding device of the family group device and transmitted to both the source devices.

While the group response sent to the source device 170 on behalf of the family group 210 is described in FIGS. 4A-4G as being generated and sent by a single member of the family group 210, the group response may be signed on behalf of multiple members of the family (as shown in FIGS. 4B, 4D and 4G) in order to indicate that the group message is the position of the entire family group 210.

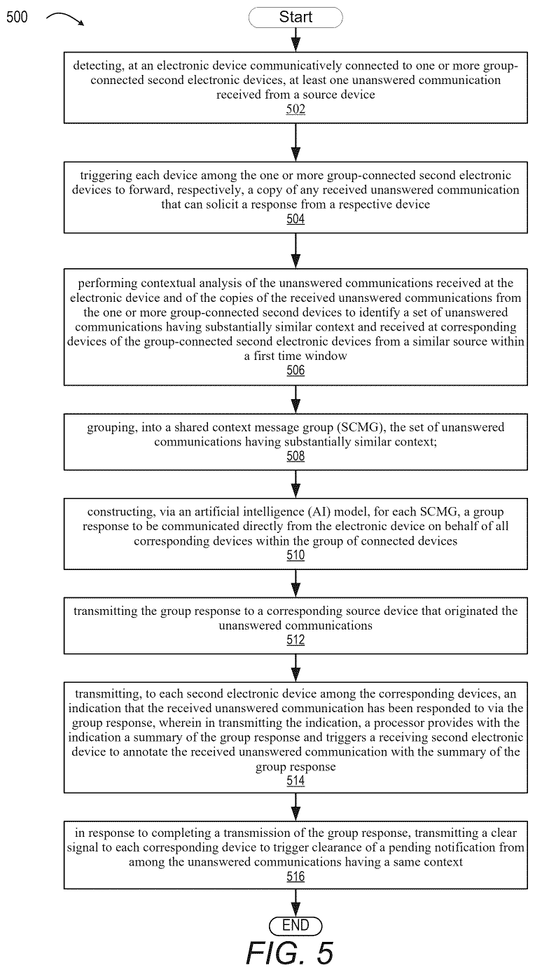

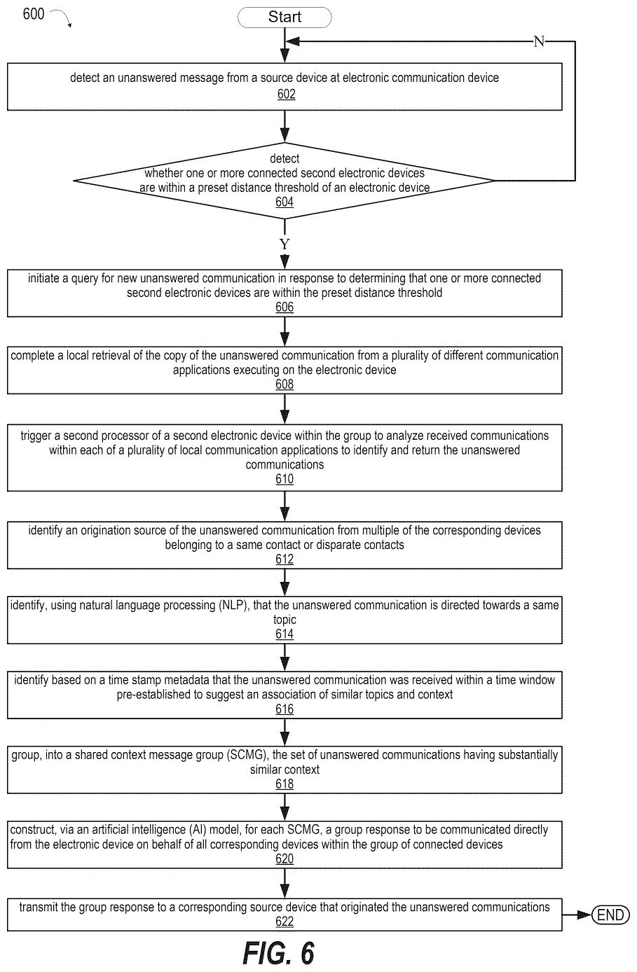

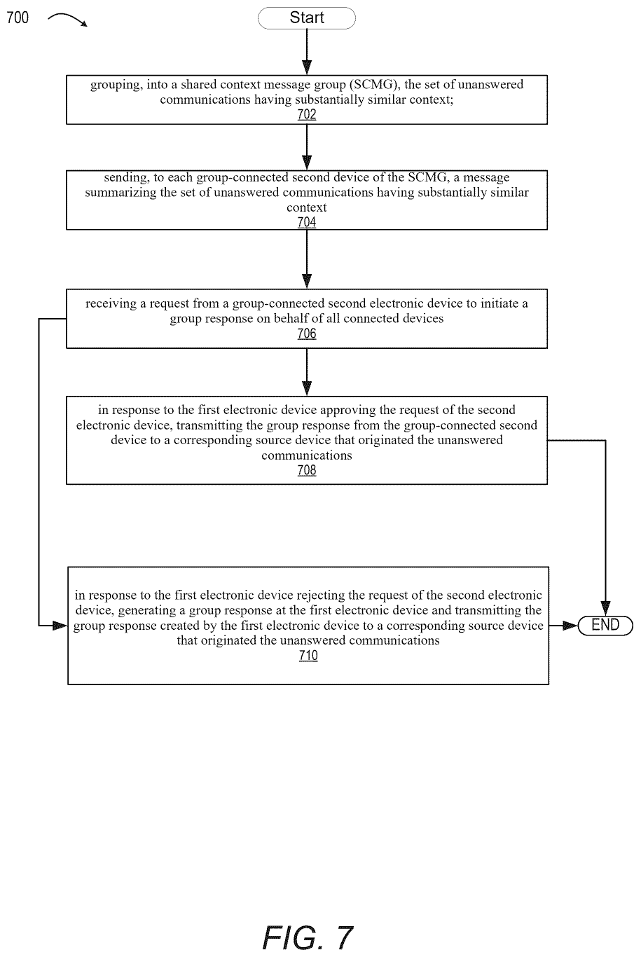

Referring now to the flowcharts presented by FIG. 5, FIG. 6, and FIG. 7, the descriptions of the methods in FIG. 5, FIG. 6, and FIG. 7 are provided with general reference to the specific components and features illustrated within the preceding FIGS. 1A-1B, FIG. 2, FIG. 3, and FIGS. 4A-4G. Specific components referenced in the methods of FIG. 5, FIG. 6, and FIG. 7 may be identical or similar to components of the same name used in describing preceding FIGS. 1A-1B, FIG. 2, FIG. 3, and FIG. 4A-4G. In one or more embodiments, processor 112 (FIG. 1A) is configured to provide the described functionality of the methods of FIG. 5, FIG. 6, FIG. 7 by executing program code for one or more modules or applications provided within device memory 120 of electronic device 100, including GDCR manager 125 (FIG. 1).

FIG. 5 depicts a flowchart of a computer-implemented method for implementation of a joint response for a plurality of electronic devices that are interconnected within a family group 210, according to one or more embodiments. The method 500 starts at block 502, where the processor 112 detects, at the electronic device 100 communicatively connected to one or more group-connected second electronic devices 170, at least one RRU communication received from a source device 320. The method proceeds to block 504, where the processor 112 triggers each device among the one or more group-connected second electronic devices 170 to forward, respectively, a copy of any received RRU communication that can solicit a response from a respective device. The method proceeds to block 506, where the processor 112 performs contextual analysis of the RRU communications received at the electronic device 100 and of the copies of the received RRU communications from the one or more group-connected second devices 170 to identify a set of RRU communications having substantially similar context and received at corresponding devices of the group-connected second electronic devices 170 from a similar source within a first time window. The method proceeds to block 508, where the processor 112 groups, into a shared context message group (SCMG), the set of RRU communications having substantially similar context. The method then proceeds to block 510, where the processor 112 constructs, via an artificial intelligence (AI) model 126, for each SCMG, a group response to be communicated directly from the electronic device 100 on behalf of all corresponding devices within the group of connected devices. The method proceeds to block 512, where the processor 112 transmits the group response to a corresponding source device 215 that originated the RRU communications. The method proceeds to block 514, where the processor 112 transmits, to each second electronic device 170 among the corresponding devices, an indication that the received unanswered communication has been responded to via the group response, wherein in transmitting the indication, a processor provides with the indication a summary of the group response and triggers a receiving second electronic device 170 to annotate the received unanswered communication with the summary of the group response. The method proceeds to block 516, where the processor 112, in response to completing a transmission of the group response, transmits a clear signal to each corresponding device to trigger clearance of a pending notification from among the unanswered communications having a same context. Then the method ends.

FIG. 6 depicts a flowchart of an additional computer-implemented method for implementation of a joint response for a group of related electronic devices, according to one or more embodiments. The method 600 starts at block 602 where the processor 112 detects an RRU message from a source device 215 at electronic communication device 100. The method proceeds to block 604, where the processor 112 detects whether one or more connected second electronic devices 170 are within a preset distance threshold of the electronic device 100. If there are no second electronic devices 170 within a preset threshold distance, the method returns to the start. If there are one or more connected second electronic devices 170 within a preset distance threshold, the method proceeds to block 606, where the processor 112 initiates a query for new RRU communication. The method proceeds to block 608, where the processor 112 completes a local retrieval of the copy of the RRU communication from a plurality of different communication applications executing on the electronic device 100. The method proceeds to block 610, where the processor 112 transmits a request that triggers a second processor 202 of a second electronic device 170 within the group to analyze received communications within each of a plurality of local communication applications to identify and return the RRU communications. The method proceeds to block 612, where the processor 112 identifies an origination source of the RRU communication from multiple of the corresponding devices belonging to a same contact. The method proceeds to block 614, where the processor 112 identifies, using natural language processing (NLP), that the RRU communication is directed towards a same topic. The method proceeds to block 616, where processor 112 identifies based on a time stamp metadata, that the RRU communication was received within a time window pre-established to suggest an association of similar topics and context. The method proceeds to block 618, where the processor 112 groups, into a shared context message group (SCMG), the set of RRU communications having substantially similar context. The method proceeds to block 620, where the processor 112 constructs, via an artificial intelligence (AI) model 126, for each SCMG, a group response to be communicated directly from the electronic device 100 on behalf of all corresponding devices within the group of connected devices. The method proceeds to block 622, where the processor 112 transmits the group response to a corresponding source device 215 that originated the RRU communications. Then the method ends.

FIG. 7 depicts a flowchart of yet another computer-implemented method for implementation of a joint response for a group of electronic devices, according to one or more embodiments. After preparatory steps consistent with the process detailed in the descriptions of FIG. 5 and FIG. 6, the method 700 starts at block 702, where the processor 112 groups, into a shared context message group (SCMG), the set of unanswered communications having substantially similar context, received from the other group devices. The method then proceeds to block 704, where the electronic device 100 sends, to each group-connected second device having a RRU message associated within the SCMG, a summary message summarizing the set of RRU communications having substantially similar context. The method proceeds to block 706, where the processor 112 receives a request from a group-connected second electronic device 170 to initiate a group response on behalf of all connected devices. The method proceeds to block 708, where the processor 112, in response to the first electronic device 100 approving the request of the second electronic device 170, transmits the group response from the group-connected second device 450 to a corresponding source device 215 that originated the unanswered communications. Then the method ends. Alternatively, the method proceeds to block 710, where the processor 112, in response to the first electronic device 100 rejecting the request of the second electronic device, generating a group response at the first electronic device 100 and transmitting the group response created by the first electronic device to a corresponding source device 215 that originated the unanswered communications. Then the method ends.

Accordingly, by implementing the above-described processes, a family or other close group may avoid the inconvenience of separately responding to electronic communication (from a same source) that concerns all or most of the members of the group. The methods disclosed herein streamline the response process by designating a single group member to generate and send a response. The described methods provide an improvement over existing processes as they allow for group members to remain informed of the current state of an electronic communication throughout the process and allow the group to respond to the source with a single voice.

In the above-described methods, one or more of the method processes may be embodied in a computer readable device containing computer readable code such that operations are performed when the computer readable code is executed on a computing device. In some implementations, certain operations of the methods may be combined, performed simultaneously, performed in a different order, or omitted, without deviating from the scope of the disclosure. Further, additional operations may be performed, including operations described in other methods. Thus, while the method operations are described and illustrated in a particular sequence, use of a specific sequence of operations is not meant to imply any limitations on the disclosure. Changes may be made with regard to the sequence of operations without departing from the spirit or scope of the present innovation. Use of a particular sequence is therefore, not to be taken in a limiting sense, and the scope of the present disclosure is defined primarily by the appended claims.

Aspects of the present innovation are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present innovation may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and their practical application, and to enable others of ordinary skill in the art to understand the disclosure for various embodiments with various modifications as suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the innovation has been described with reference to example embodiments, it will be understood by those skilled in the art that various changes may be made, and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display embedded in a user accessible surface of the electronic device;
a communications subsystem that enables the electronic device to communicatively connect via a wireless connection to one or more networks and one or more group-connected second electronic devices;
a memory having stored thereon a group-connected devices common response (GDCR) module for consolidating notifications and communications received by multiple group-connected electronic devices and enabling generation and transmission of a group response; and
at least one processor communicatively coupled to the display, the communications subsystem, and the memory, the at least one processor executing program code of the GDCR module, and configured to cause the electronic device to:
detect at least one unanswered communication received at the electronic device from a source device;
trigger each device among the one or more group-connected second electronic devices to forward, respectively, a copy of any received unanswered communication that can solicit a response from a respective device;
perform contextual analysis of the unanswered communications received at the electronic device and of the copies of the received unanswered communications from the one or more group-connected second devices to identify a set of unanswered communications having substantially similar context and that are received, at corresponding devices within the group of connected devices, from a similar source within a first time window;
group, into a shared context message group (SCMG), the set of unanswered communications having substantially similar context;
construct, via an artificial intelligence (AI) model, for each SCMG, a group response to be communicated directly from the electronic device on behalf of all corresponding devices within the group of connected devices; and
transmit the group response to a corresponding source device that originated the unanswered communications.

2. The electronic device of claim 1, wherein the at least one processor is further configured to cause the electronic device to:
transmit, to each second electronic device among the corresponding devices, an indication that the received unanswered communication has been responded to via the group response.

3. The electronic device of claim 2, wherein in transmitting the indication, the at least one processor provides with the indication a summary of the group response and triggers a receiving second electronic device to annotate the received, unanswered communication with the summary of the group response.

4. The electronic device of claim 1, wherein the processor is further configured to cause the electronic device to:
detect when one or more connected second electronic devices are within a preset distance threshold of the electronic device; and
initiate a query for new unanswered communications, in response to determining that one or more connected second electronic devices are within the preset distance threshold.

5. The electronic device of claim 1, wherein to identify a set of unanswered communications having substantially similar context, the at least one processor is configured to cause the electronic device to:
identify an origination source of the unanswered communication from multiple of the corresponding devices belonging to a same contact;
identify, using natural language processing (NLP), that the unanswered communication is directed towards a same topic; and
identify based on a time stamp metadata that the unanswered communication was received within a time window pre-established to suggest an association of similar topics and context.

6. The electronic device of claim 1, wherein the processor is further configured to cause the electronic device to:
complete a local retrieval of the copy of the unanswered communication from a plurality of different communication applications executing on the electronic device; and
trigger a second processor of a second electronic device within the group to analyze received communications within each of a plurality of local communication applications to identify and return the unanswered communications.

7. The electronic device of claim 1, the processor being further configured to cause the electronic device to:
in response to completing the transmission of the group response:
transmit a clear signal to each corresponding device to trigger clearance of a pending notification from among the unanswered communications having a same context.

8. The electronic device of claim 1, the processor being further configured to cause the electronic device to initiate the triggering of each device among the one or more group-connected second electronic devices in response to detection of a predetermined trigger word uttered by the user of the electronic device.

9. The electronic device of claim 1, the processor being further configured to cause the electronic device to send a prompt to the group-connected second electronic devices giving each user of the respective second electronic devices an option to enter a selective sharing configuration whereby the group-connected second electronic devices may restrict the unanswered communications forwarded to the electronic device to unanswered communications from specified communication applications.

10. The electronic device of claim 1, the processor being further configured to cause the electronic device to:
receive a request from a group-connected second electronic device to initiate the group response on behalf of all connected devices; and
in response to receiving the request, generate and present a prompt for entry of a user input that indicates one of:
approve the request and transmit a group response to the corresponding source device; or
deny the request and transmit a denial of the request to the second electronic device.

11. A method comprising:
detecting, at an electronic device communicatively connected to one or more group-connected second electronic devices, at least one unanswered communication received from a source device;
triggering each device among the one or more group-connected second electronic devices to forward, respectively, a copy of any received unanswered communication that can solicit a response from a respective device;
performing contextual analysis of the unanswered communications received at the electronic device and of the copies of the received unanswered communications from the one or more group-connected second devices to identify a set of unanswered communications having substantially similar context and received at corresponding devices of the group-connected second electronic devices from a similar source within a first time window;
grouping, into a shared context message group (SCMG), the set of unanswered communications having substantially similar context;
constructing, via an artificial intelligence (AI) model, for each SCMG, a group response to be communicated directly from the electronic device on behalf of all corresponding devices within the group of connected devices; and
transmitting the group response to a corresponding source device that originated the unanswered communications.

12. The method of claim 11, further comprising:
transmitting, to each second electronic device among the corresponding devices, an indication that the received unanswered communication has been responded to via the group response, wherein in transmitting the indication, a processor provides with the indication a summary of the group response and triggers a receiving second electronic device to annotate the received unanswered communication with the summary of the group response.

13. The method of claim 11, further comprising:
detecting when one or more connected second electronic devices are within a preset distance threshold of the electronic device; and
initiating a query for new unanswered communication in response to determining that one or more connected second electronic devices are within the preset distance threshold.

14. The method of claim 11, further comprising:
in identifying a set of unanswered communications having substantially similar context:
identifying an origination source of the unanswered communication from multiple of the corresponding devices belonging to a same contact or disparate contacts;
identifying, using natural language processing (NLP), that the unanswered communication is directed towards a same topic; and
identifying based on a time stamp metadata that the unanswered communication was received within a time window pre-established to suggest an association of similar topics and context.

15. The method of claim 11, further comprising:
completing a local retrieval of the copy of the unanswered communication from a plurality of different communication applications executing on the electronic device; and
triggering a second processor of a second electronic device within the group to analyze received communications within each of a plurality of local communication applications to identify and return the unanswered communications.

16. The method of claim 11, further comprising:
in response to completing a transmission of the group response, transmitting a clear signal to each corresponding device to trigger clearance of a pending notification from among the unanswered communications having a same context.

17. The method of claim 11, further comprising:
receiving a request from a group-connected second electronic device to initiate the group response on behalf of all connected devices; and
in response to receiving the request, receiving a user input that performs one of:
approving the request and transmitting a group response to each corresponding source device; or
denying the request.

18. A computer program product comprising a non-transitory computer readable medium having program instructions that when executed by a processor of an electronic device communicatively connected via a wireless connection to one or more group-connected second electronic devices, configure the electronic device to perform functions comprising:
detecting, at an electronic device communicatively connected to one or more group-connected second electronic devices, at least one unanswered communication received from a source device;
triggering each device among the one or more group-connected second electronic devices to forward, respectively, a copy of any received unanswered communication that can solicit a response from a respective device;
performing contextual analysis of the unanswered communications received at the electronic device and of the copies of the received unanswered communications from the one or more group-connected second devices to identify a set of unanswered communications having substantially similar context and received at corresponding devices within the group-connected devices from a similar source within a first time window;
grouping, into a shared context message group (SCMG), the set of unanswered communications having substantially similar context;
constructing, via an artificial intelligence (AI) model, for each SCMG, a group response to be communicated directly from the electronic device on behalf of all corresponding devices within the group of connected devices; and
transmitting the group response to a corresponding source device that originated the unanswered communications.

19. The computer program product of claim 18, further comprising program instructions for:
transmitting, to each second electronic device among the corresponding devices, an indication that the received unanswered communication has been responded to via the group response, wherein in transmitting the indication, the at least one processor provides with the indication a summary of the group response and triggers a receiving second electronic device to annotate the received, unanswered communication with the summary of the group response.

20. The computer program product of claim 18, further comprising program instructions for:
in response to completing a transmission of the group response, transmitting a clear signal to each corresponding device to trigger clearance of a pending notification from among the unanswered communications having substantially similar context.
